(19) United States
(12) Patent Application Publication
(10) Pub. No.: US 2007/0143205 A1
(43) Pub. Date: Jun. 21, 2007

(54) Method and system for implementing configurable order options for integrated auction services on a seller's e-commerce site

(75) Inventors: Birgit Starmanns, Mountain View, CA (US); Guruprasad Srinivasamurthy, Cupertino, CA (US); Lenin K. Subramanian, Palo Alto, CA (US)

Correspondence Address: KENYON & KENYON LLP, 1500 K STREET N.W., WASHINGTON, DC, 20005, US

(73) Assignee: SAP AG

(21) Appl. No.: 11/591,133

(22) Filed: Oct. 31, 2006

Related U.S. Application Data
(60) Provisional application No. 60/731,249, filed on Oct. 31, 2005.

(51) Int. Cl. G06Q 40/00

(52) U.S. Cl. 705/37

(57) ABSTRACT

An internal auction system may allow a seller to designate configurable order options for an auction using an internal auction application. These configurable order options may include a product configuration option, an accessory option, a cross-selling product option, an up-sell product option, and a down-sell product option. A configuration order option may be associated with a product in a seller's business information management system and may be automatically included in the auction when the product is added to the auction. A seller may also manually specify the configurable order option for the auction or product in the auction where the configurable order option is defined for this auction only and is not stored with the product for further use.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to a method and system for providing integrated auction services through a seller's e-commerce site. In particular, the present invention relates to providing configurable order options for an auction so that a winning bidder may tailor an auction order.

### BACKGROUND

Businesses traditionally look for effective ways in which to make their products available to potential buyers. In addition to sales through physical “brick and mortar” stores, innovative ways to sell products are often used especially to dispose of old or excess inventory. The advent of the Internet along with the accompanying revolution in computer and network technology has created new sales paradigms and allowed businesses to establish their own electronic commerce (“e-commerce”) presence through the use of, for example, Internet Web sites. E-commerce sales have steadily grown and now account for a significant portion of business-to-consumer as well as business-to-business sales. Auctions make up a significant portion of e-commerce sales and have grown into an increasingly more important sales paradigm.

The revolution in network and computer capability along with the mass availability and development of the Internet facilitates alternative methods of sales such as auctions. Network-based electronic auctions, such as for example those conducted over the Internet, may allow a seller considerable control over an auction and may increase auction participation. For example, a seller may want to limit participation in the auction where the pool of potential customers is limited or where allowing an open auction may, in some manner, hinder the auction process. In another example where an auction may be open to all potential bidders it is often beneficial to maximize the number of people participating in the auction in order to extract the greatest price for the product or lot being auctioned. The Internet and network-based computing provide the ability to aggregate large numbers of bidders for an auction in an easier and generally less costly manner than through traditional auctions. Though network-based auctions (e.g., Internet based auctions) provide significant advantages, the reliance on third party auction providers has limited a seller's control in a number of ways including through rules on the conformance of auction procedures and the loss of control over restricting auction participation and bidding.

Third party auction providers provide a large scale e-commerce community portal that brings together large numbers of buyers and sellers who gather to trade in goods and services. Everyday, millions of items across thousands of categories are available on third party auction providers for sale by auction and for a fixed price, enabling trade on a local, national, and international basis with customized Internet Web sites in markets around the world. These third party auction providers may provide auction services for the seller as well as access to a ready pool of potential buyers but in exchange they may require a seller to conform their auctioning processes and procedures. In addition, a third party auction provider typically takes a fee that may be fixed or proportional to the value of the auctioned goods and/or services. In both cases, the seller loses some degree of control over the auction process in exchange for using the third party auction service.

In addition to the limitations on auction procedures and processes imposed by a third party auction provider, a business may not be able to make maximum use of its business information in providing and generating auctions through a third party auction service. Businesses have typically kept their information, including information regarding their assets and inventory they wish to sell or auction off, in database systems that are part of their corporate information systems. Conventional systems provide limited linking between these business information management systems and online Web auction services, and, therefore, manual involvement with the Web auction service is required for each auction or sales posting conducted. These problems may be overcome and the limitations of third party auction services avoided by providing auction services through a seller's own e-commerce site. In this manner, full advantage may be taken by linking a seller's business information management systems with its e-commerce site allowing greater automation of the auction submission, tracking, and post-auction processing. An integrated internal auction system solves these problems in a novel manner providing considerable advantages to a seller. In this manner, a seller may be able to provide configurable order options to a winning bidder through a seller's internal auction system.

### BRIEF DESCRIPTION OF THE DRAWINGS

FIG. 1 is a diagram illustrating the integrated internal auction system according to one embodiment of the present invention.

FIG. 2 is a flowchart illustrating the auction creation process using an internal auction application where configurable order options may be designated for the auction according to one embodiment of the present invention.

FIG. 3 is a flowchart illustrating the auction process using an internal auction application where configurable order options may be designated for the auction according to one embodiment of the present invention.

FIG. 4a is an example data architecture for implementing a configurable order option in an auction within an internal auction system according to one embodiment of the present invention.

FIG. 4b is an example data architecture for implementing a configurable order option associated with a product in an auction within an internal auction system according to one embodiment of the present invention.

FIG. 5 is a screen shot from an internal auction application illustrating an auction listing screen from which a seller may choose to create a new auction or edit an existing auction where a configurable order option may be included according to one embodiment of the present invention.

FIG. 6 is a screen shot from an internal auction application illustrating an auction creation screen from which a configurable order option may be specified according to one embodiment of the present invention.

FIG. 7 is a screen shot from an internal auction application illustrating the change rules screen presented to a seller during the auction creation process according to one embodiment of the present invention.

FIG. 8 is a screen shot from an internal auction application illustrating the auction creation screen with general auction information entered according to one embodiment of the present invention.

FIG. 9 is a screen shot from an internal auction application illustrating the initiation of a process to add a product to an auction which may also associate configurable order options with the auction according to one embodiment of the present invention.

FIG. 10 is a screen shot from an internal auction application illustrating the product designation screen of the auction creation process where a product may be included in an auction according to one embodiment of the present invention.

FIG. 11 is a screen shot from an internal auction application illustrating the adding of a product to an auction on the product designation screen during the auction creation process according to one embodiment of the present invention.

FIG. 12 is a screen shot from an internal auction application illustrating the selected products for an auction which may also associate configurable order options with the auction according to one embodiment of the present invention.

FIG. 13 is a screen shot from a seller's e-commerce site illustrating an auction order processing page available to a winning bidder through a seller's e-commerce site that may contain configurable order options according to one embodiment of the present invention.

FIG. 14 is a block diagram illustrating the platform on which the method and system for providing a configurable order option for an auction in an internal auction system using an internal auction application may operate according to one embodiment of the present invention.

### DETAILED DESCRIPTION

In one embodiment of the present invention, an internal auction system may provide a seller an integrated auction capability linking a seller's business information management system(s) with a seller's e-commerce site. The internal auction system may allow a seller to designate configurable order options for the auction using an internal auction application. These configurable order options may include a product configuration option, an accessory option, a cross-selling product option, an up-sell product option, and a down-sell product option. The internal auction application may allow a seller to generate an auction using an available seller's business information management system, publish the auction on a seller's e-commerce site, process an auction winner, and monitor ongoing auctions in a manner leveraging a seller's existing business information management system(s) and e-commerce site(s). The internal auction application may also provide buyer functionality on a seller's e-commerce site to view and participate in published auctions, to monitor auctions and bidding, and to perform any necessary checkout process for on any auction won. The internal auction application may serve as the conduit between seller's business information management system(s) and e-commerce site(s) while providing seller and/or buyer functionality to implement an integrated auction capability under the seller's internal control (i.e., without using an external third party auction provider or facilitator).

A configuration order option may be associated with a product and/or service in a seller's business information management system and the inclusion of the product or service in the auction may allow, through either a fully or semi-automated process, the inclusion of the associated configuration order option into the auction in one embodiment of the present invention. The process for the inclusion into an auction of an already defined configuration order option associated with a product or service in a business information management system may be considered fully automated if the configuration order option is added to the auction as a consequence, without further seller action, of adding the product or service to the auction. For example, a seller adding product A to an auction may result in the automatic inclusion of any associated configuration order options for product A into the auction. The seller may then review, edit, and/or delete these options. The process for including a configuration order option already defined and associated with a product or service in a seller's business information management system may be considered semi-automated if a seller action is required to include the configuration order option. For example, a seller adding to an auction a product B having an associated configuration order option X may result in a prompt to the seller asking whether to include configuration order option X in the auction. In another example, a seller using the internal auction application may be able to select (e.g., highlight in a table) a product added to an auction and then choose an import associated configurable order items option (e.g., a button, pull-down menu option, hyperlink, etc.) to select from or import all the configurable order options associated with the product.

In another embodiment of the present invention, a configurable order option may be defined by a seller for a product or service in an auction using the internal auction application. According to this embodiment, the seller may manually specify the configurable order option which may be associated with the product or service only in this auction and not in the seller's business information management system. In this manner a one-time or limited configurable order option may be defined and associated with the product or service. This is different than defining a configurable order option in the seller's business information management system and associating the defined configurable order option with a product or service in the seller's business information management system.

In another embodiment of the present invention, a method and system for providing a configurable order option for an auction in an internal auction system using an internal auction application allows a seller's business information management system to receive a product parameter from the internal auction application and, using the product parameter, to retrieve data for the product in the business information management system as well as to identify any configurable order options in the business information management system associated with the product. According to this embodiment, the retrieved and/or identified data may then be returned to the internal auction application to include in the auction. The seller's business information management system may also receive an order for the auction from a winning bidder with the order containing a selection for the configurable order option. This order may be processed according to the selection for the configurable order option.

According to one embodiment of the present invention, the internal auction application links a seller's e-commerce site with a seller's existing business information management system(s) in order to provide auction services to buyers through the seller's e-commerce site. A seller's e-commerce site according to this embodiment may be any electronic business presence that a seller provides to potential buyers. For example, a seller's Web site on the Internet that offers information on or purchase of seller's products can be considered a seller's e-commerce site. A seller's business information management system according to this embodiment may be any seller information system containing product and/or sales and marketing information that may be used in the provision of products to a buyer. For example, a seller's inventory system that tracks the availability of seller's products may be considered one form of many potential seller's business information management systems. A seller's business information management system implies business applications using a programming and/or program interface working with a database to accomplish one or more tasks. However, according to this embodiment a seller's business information management system may be considered both the database and the interface to access the database by itself as well as this database and associated interface in conjunction with associated applications. The internal auction application according to this embodiment provides the functionality to implement the auctioning of seller products (i.e., products sold by the seller) on the seller's e-commerce site in conjunction with using at least one of the seller's business information management systems. In one embodiment, the internal auction application is a component-based multi-tier application developed according to the Java® 2 platform, enterprise edition standard (J2EE®) and running on top of a web application server (WAS). The auction application is linked to a business information management system using business information management system plug-ins to tie the auction application to the business information management system backend functions.

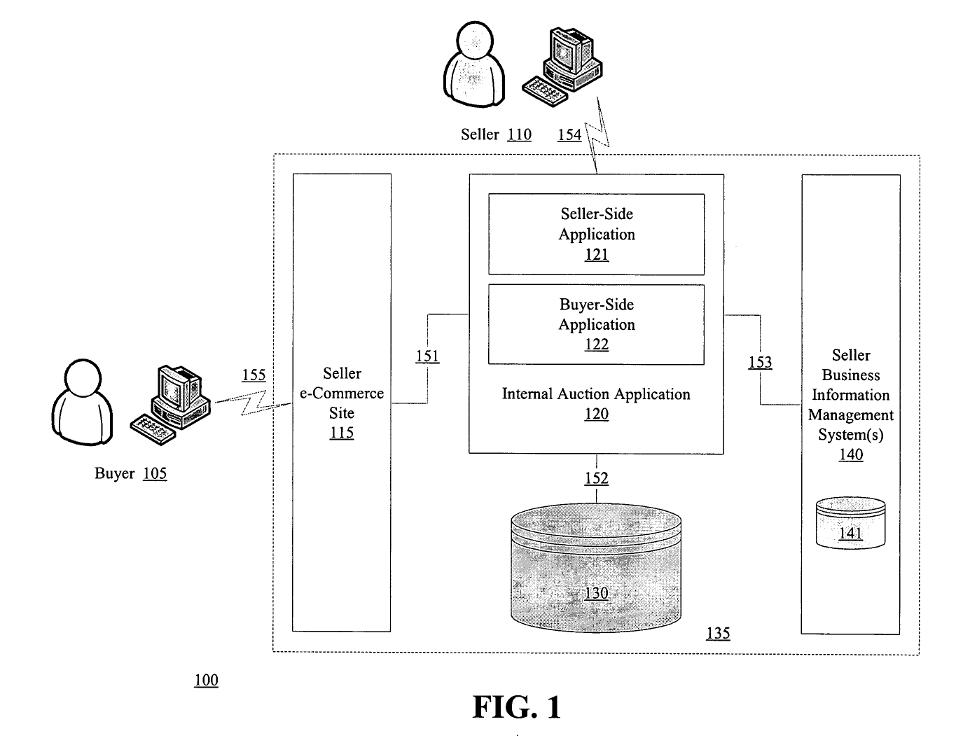

FIG. 1 is a diagram illustrating the integrated internal auction system according to one embodiment of the present invention. A seller 110 may create an auction using an internal auction application 120 residing on the seller's information technology hardware environment 135. For example, the internal auction application 120 may consist of one or more software applications, programs, modules, procedures, or other computer code to include firmware and may additionally include data that resides on one or more servers, computers, or other hardware platforms that make up the seller's information technology hardware environment 135. The internal auction application 120 may be conceptualized as containing a seller-side application 121 handling the seller interaction 154 with the integrated internal auction system 100 through the internal auction application 120. The seller-side application 121 may provide the functionality allowing the seller 110 to create, monitor, and manage one or more auctions. The internal auction application 120 may also be conceptualized as containing a buyer-side application 122 handling the buyer interaction 155 with the integrated internal auction system 100 and allowing buyer interaction 155 with the internal auction application 120 and the seller's business information management system(s) 140 through a seller's e-commerce site 115. The buyer-side application 122 may provide the functionality allowing the buyer 105 to view auctions, participate in active auctions, monitor auctions, and perform the checkout process on won auctions. Though conceptually the functionality provided by the seller-side application 121 and the buyer-side application 122 of the internal auction application 120 are different, both may share data sets, procedures, libraries, and other elements of software code or data. In one embodiment of the present invention, all the elements of the internal auction application 120 may either be contained in both the conceptual subsets-seller-side application 121 and buyer-side application 122—or in an alternative embodiment the internal auction application 120 may contain additional elements of software code and/or data in addition to these conceptual subsets 121, 122. The internal auction application 120 uses data that may be contained in a seller's business information management system(s) 140 and/or may be stored in a local database 130 for the internal auction application 120. This local database 130 may be considered part of the internal auction application 120 in this embodiment of the present invention even if the database is stored separately in a memory or storage system.

An internal auction application 120 may communicate 152 with the local database 130; communicate 153 with the seller's business information management system(s) 140; and communicate 151 with the seller's e-commerce site 115 using a communication network that is part of the seller's information technology hardware environment 135. For example, the seller's e-commerce site 115, internal auction application 120, local database 130, and business information management system(s) 140 may be located on servers or other computers that are part of a communication network—such as a local area network (LAN) or wide area network (WAN)—controlled by the seller. In an alternative embodiment, the seller's information technology hardware environment 135 may include a communication network that is shared by the seller with other network users. For example, the seller's e-commerce site 115, internal auction application 120, local database 130, and business information management system(s) 140 may be located on servers or other computers that are part of at least one internal seller communication network (e.g., a LAN and/or WAN) as well as a shared (i.e., shared by seller with other non-seller related entities) communication network such as the Internet. In either embodiment regardless of the network used for communication between the elements of the integrated auction system 100, seller communication 154 and buyer communication 155 with the integrated auction system 100 may occur over an external network (i.e., a network external to the seller and not under the seller's direct control), such as for example, the Internet. In an alternative embodiment, seller and buyer communication 154, 155 with the integrated auction application 100 may occur over a seller-controlled network (such as a seller-controlled wide area sales network) and/or may involve a combination of at least one seller-controlled network and at least one external network.

The integrated auction system 100 integrates a seller's business information management systems(s) 140, which serves as a backend system(s), with a seller's e-commerce site 115, serving as a front-end system, using an internal auction application 120 in order to provide auction services to the seller 110 and the buyer 105 according to one embodiment of the present invention. A seller business information management system 140 is a an application with at least one associated database 141 typically using a database management system (DBMS) that provides data storage and associated programming support for that data (e.g., a query system such as an SQL editor, optimization routines, program interfaces). For example, a seller may have an inventory control system 140 with its own inventory database 141. The business information management system(s) 140 may contain product information and availability information used in generating an auction and performing order generation to fulfill a winning bidder's order according to one embodiment of the present invention. The seller's e-commerce site 110 allows a buyer 105 to participate in an auction over a communication network. For example, a seller Web site on the Internet offering goods and/or services (electronic commerce) is one example of a seller e-commerce site 115. An auction in the integrated auction system 100 is made available to the buyer 105 through the seller e-commerce site 115 which may serve as the buyer portal to the integrated auction system 100 according to one embodiment of the present invention. The seller 110 creates and manages auctions through the internal auction application 120 which integrates 153 information from the business information management system(s) 140 and provides the interaction processing 151 with the buyer 105 through the seller e-commerce site 115.

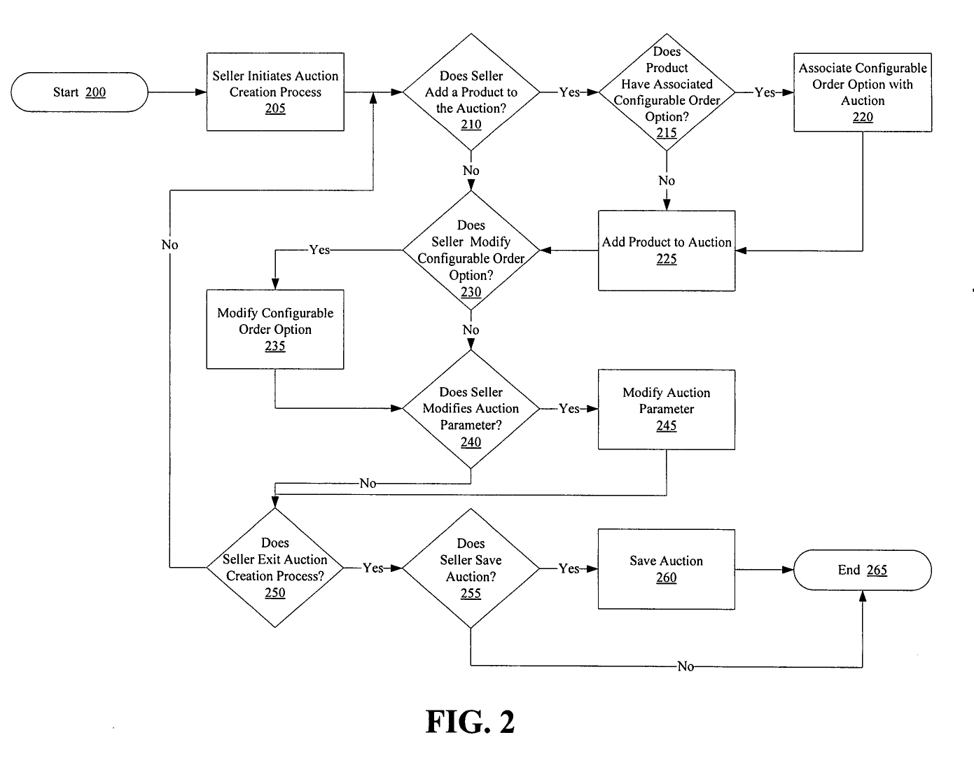

FIG. 2 is a flowchart illustrating the auction creation process using an internal auction application where configurable order options may be designated for the auction according to one embodiment of the present invention. The process begins 200 when a seller 110 using the seller-side application 121 of the internal auction application 120 selects an option 205 (e.g., from a pull-down menu, button, copying an existing or previously created auction, etc.) to create an auction. The seller initiation of the auction creation process 205 allows the seller 110 to define the products and/or services to be auctioned as well as any auction parameters relating to the auction. Though the embodiments discussed herein refer to the auctioning of products, it should be understood that the term products also covers services in other embodiments of the present invention. During the auction creation process, a seller 110 may add a product and/or service to the auction 210 through a selection and/or specification means provided through the seller-side application 121 of the internal auction application 120. For example, the seller-side application 121 of the internal auction application 120 may provide a link to a product catalog in a seller's business information management system 140. The product catalog may contain a listing of the products that the seller makes available to buyers and the product catalog may also contain predefined product data such as, for example, a product description, a product image, etc. which may be used in generating the auction. A seller 110 may browse through or search the product catalog in the seller's business information management system 140 through the link provided in the seller-side application 121 in order to choose one or more products to add to the auction 210 according to this example embodiment. In another example, product information in a seller's business information management system(s) 140 may be accessed through a seller-side application using data reporting tools (not shown) that assist in the retrieval and/or display of data (in this case product data) in an database system 140. In a third example embodiment, a seller 110 may enter a product identifier in the seller-side application 121 to indicate the desired product rather than browsing or searching product information in a seller's business information management system(s) 140. These three example embodiments are some of many ways in which a seller 110 may enter product information during the auction creation process and these embodiments are not intended to limit the scope of the seller-side application 121 or the internal auction application 120.

A product selected for an auction may have associated data in the seller's business information management system(s) 140 that may be used to facilitate the creation of the auction and to rapidly provide common product information. For example as previously stated, a product description may already exist for the product in the seller's business information management system(s) 140. This product description may, for example, be retrieved and used in the auction when the product is added to the auction thereby reducing a possible need for the additional entry of information by the seller 110 and leveraging existing product information. One example of the information that may already be associated with a product in a seller's business information management system(s) is a configurable order option. A configurable order option may be an ordering option associated with the product that provides some flexibility to the product and/or the order. For example, a configurable order option may include product configuration options such as, for example, variable processor speeds or different available colors. If the product is a desktop computer, the computer may come in several colors that a customer 105 may select during the checkout process when the customer 105 places an order with the seller 110. In an auction environment such as the internal auction system 100, a customer 105 may select the computer color during the checkout process if the customer 105 wins the auction. In another example, a processor may be an example of a product that may be ordered with different processing speeds. A customer 105 may be able to specify the processor speed when placing an order for the processor with the seller 110 and, therefore, the customer 105 may be provided with this configurable order option during the checkout process for an auction if the customer 105 is the auction winner. In addition to these product configuration options, a configurable order option may also be an option for an accessory associated with the product that is necessary to use the product or is optional and enhances product use. For example, a laptop computer may be a product that has accessories such as, for example, a battery and a power supply, that may be sold separately or where additional units may be desired by a customer 105 in conjunction with an order. In an internal auction system 100, an accessory option may also be a configurable order option that a customer 105 winning the auction may select from during the checkout process for the auction order. In addition to a product configuration option and an accessory option, a configurable order option may also include an option for a cross-selling product related to the product in the auction. For example, a laptop computer may be a product having a related cross-selling product of a laptop case that may be a configurable order option during the checkout process for the laptop. In an internal auction environment 100, a customer 105 winning an auction may be able to include a selection for the cross-selling product in the auction order for the product during the checkout process. Another example of a configurable order option in addition to a product configuration option, an accessory option, and a cross-selling product option is an option for an up-sell capability where a customer may upgrade the product to an improved model. For example, a customer 105 purchasing a television may have a configurable order option during the checkout process to upgrade the television to a larger screen-size. In an internal auction system 100, an up-sell capability (also referred to herein as an up-sell product option) may also be a configurable order option a winning bidder 105 may be presented with during the checkout process for the auction order. Just as an up-sell capability may exist as a configurable order option, a down-sell capability (also referred to herein as a down-sell product option) may exist as well allowing a customer to, for example, select a product in a range of products where both an up-sell and down-sell capability are provided. A product configuration option, an accessory option, a cross-selling product option, an up-sell product option, and a down-sell product option are all examples of the types of configurable order options that may be associated with a product. In an internal auction system 100, these configurable order options may be included in an auction during the auction creation process.

During the auction creation process, a seller 110 may add a product to the auction 210. If this product already has an associated configurable order option 215, that configurable order option may also be associated with the auction 220 when adding the product to the auction 225 according to this embodiment of the present invention. A product may already have a configurable order option associated with it in the seller's business information management system(s) 140. For example, the database entries in the seller's business information management system(s) 140 may indicate that the product comes in several processor speeds each being a product configuration option type of configurable order option that may be included in an auction according to this example embodiment. In this example, a seller 110 adding this processor to an auction may automatically associate the different processor speeds as configurable order options for the product. The different processor speeds may result in a difference to the price of the product so a product configuration option may also include an indication of an extra charge associated with this configurable order option and a decreased product configuration capability may also include an indication of a price reduction resulting from the selection of this configurable order option. For example, if the auction is for a processor with a default specified speed of B, the winning bidder 105 may be presented with a configurable order option during the checkout process where the customer 105 may choose to purchase the processor with speed B at the auction price, the customer 105 may instead choose the configurable order option for an upgraded processor speed A which may have an increased fee of $150 for example, and the customer 105 may alternatively choose the configurable order option for a decreased processor speed of C which may result in a price reduction of $75 for example. The product has an associated configurable order option 215 if one is already defined in the seller's business information management system(s) 140 according to this embodiment. These already defined configurable order options that are associated with a product may automatically be included into the auction when the product is added to the auction according to one embodiment of the present invention. In another embodiment, the seller 110 may be presented with an option for including the associated configurable order options when the seller 110 adds the product requiring the seller to take an affirmative step (i.e., a seller action is required) to include the configurable order option in the auction 220.

In addition to adding a product to an auction 210, 225, a seller 110 may also modify configurable order options 230 during the auction creation process according to this embodiment of the present invention. The decision to modify a configurable order option 230 may include adding a configurable order option to the order 235, deleting an existing configurable order option in the order 235, and/or modify an existing configurable order option in the order 235 according to this embodiment. A seller 110 may add a configurable order option 235 when, for example, the seller 110 wants an option that is not already associated with a product 215 in the seller's business information management system(s) 140 and can not therefore be associated with the auction 220 when the product is added or when, for example, a configurable order option associated with a product in the seller's business information management system(s) 140 added to the auction is removed and the seller 110 wants to restore the configurable order option to the auction. A seller 110 may also choose to remove an existing configurable order option from the auction particularly when a large number of such options may have been automatically added 220 when a product is first associated with an auction 215 according to one embodiment of the present invention. A seller 110 may also choose to modify a configurable order option in an auction when particular information and selection for the option are not relevant to the current auction. For example, a configurable order option for a processor may exist for a processor speed product configuration option with a default speed of B but with the option to select speeds A, C, and D during the checkout process. If the seller 110 will not have any processors with speed A available, the seller 110 may remove this selection from the configurable order option for processor speed. In this same example, if none of the alternate speed processors (speeds A, C, and D) are available, the seller 110 may want to remove the entire configurable order option for this product capability (i.e., processor speed) from the auction.

In addition to addition to choosing to add products 210 to an auction along with configurable order options which may or may not be associated with the product in the seller's business information management system(s), a seller 110 may also choose 240 to modify other auction parameters 245. The auction parameters may include, for example, general auction details such as start date and time and end data and time for the auction. The seller 110 may decide to exit from the auction creation process 250 at any time or may continue making modifications as desired. If the seller 110 decides to exit from the auction creation process 250, he/she may choose 255 to save the auction information 260 already associated with the auction and end the auction creation process 265. The seller 110 may also exit from the auction process 250 without saving the auction 255 and abandon any changes he/she made while ending from the auction creation process 265. Though the embodiments discussed above relate to the auction creation process, these same options may also be available while editing/modifying an already created auction according to one embodiment of the present invention.

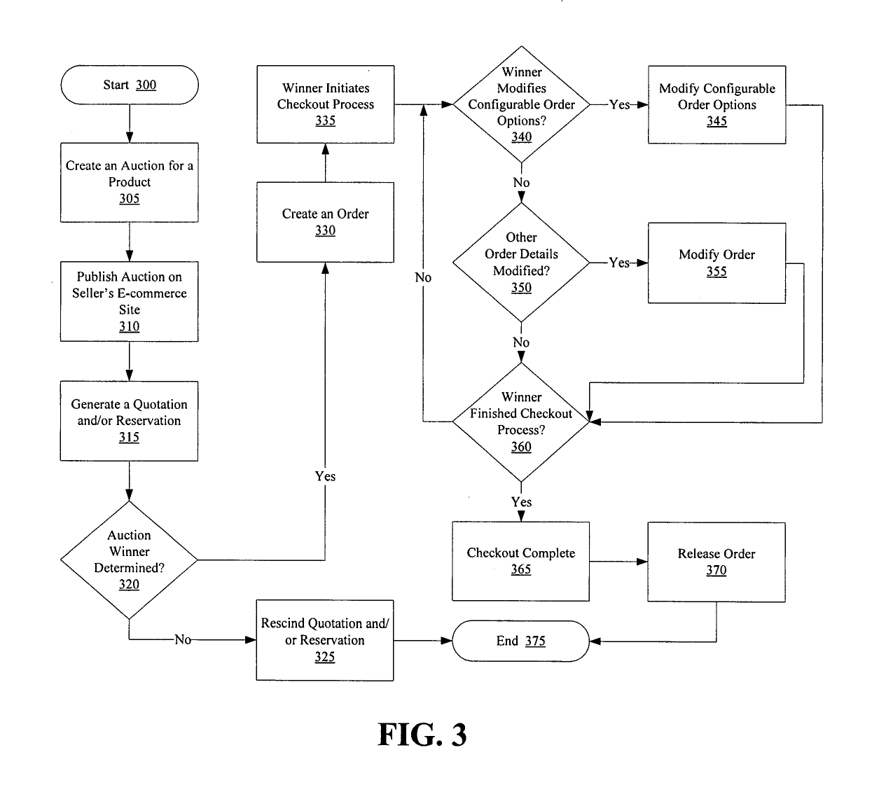

FIG. 3 is a flowchart illustrating the auction process using an internal auction application where configurable order options may be designated for the auction according to one embodiment of the present invention. The process outlined in FIG. 3 covers one embodiment of the entire auction process whereas the process outlined in FIG. 2 covered in greater detail one embodiment of the auction creation process only—a single step in the process shown in FIG. 3. The auction process begins 300 when a seller 110 using the seller-side application 121 of the internal auction application 120 selects an option 305 (e.g., from a pull-down menu, button, copying an existing or previously created auction, etc.) to create an auction as previously discussed. This seller initiation of the auction creation process 305 not only allows a seller 110 to define auction parameters and add products to the auction, it may also allow the seller 110 to associate configurable order options with the auction that may be used to tailor an auction order by a winning bidder 105 during the checkout process (discussed later). During the auction creation process 305, a seller 110 may decide to add products to the auction 210, add and modify configurable order options 215, 235, and set auction parameter values 240. An auction may be created from a “blank slate” where all auction parameters need to be specified by the seller 110 or an auction may be created using default values for the auction parameters. For example, if a new auction is created by copying another already created auction the auction parameters for the new auction may contain as default values the auction parameter values from the copied auction. In another example, a seller 110 may establish an auction profile in the seller-side application 121 of the internal auction application 120 according to one embodiment of the present invention. This auction profile may include default values (e.g., auction rules) that may be used for a newly created auction. Whether an auction is created using default values or whether auction parameters are empty and await seller specification, the seller 110 may decide to update auction parameters 240 during the auction creation process. If the seller attempts to modify an auction parameter 240, any rules regarding valid values for those auction parameters may be used to verify the values before the auction parameter is modified 245. The publication of the auction 310 may be initiated through the seller-side application of the internal auction application 120 making the auction available to a bidder 105 through the seller's e-commerce site 115 according to this embodiment.

The publication of the auction 310 may initiate the generation of a quotation and/or reservation 315. A quotation is a sales document specifying the product(s) and quantities quoted to a buyer for a potential sale, which in this case would encompass the published auction. The quotation may be generated at other points in the auction process in other embodiments of the present invention. The quotation 315 may be used to create a reservation of the auction quantity of a product in the seller's business information management system(s) 140 to ensure the availability of the quantity for the auction winner(s). If, however, a configurable order option exists that allows a change in the product, a reservation mechanism may need to be abandoned or modified to account for the configurable order option. For example, if an up-sell product option and a down-sell product option are configurable order options in an auction, the winning bidder 105 may be able to choose from several possible products during the checkout process. In order to accommodate the potential variations to the order, either all combinations may need to be reserved or no reservation may be made.

Once an auction has been published 310 with any quotation and/or reservation generated 315, an auction is active until it concludes (terminating and concluding are used interchangeably herein regarding auctions). Auction termination may be caused by any number of reasons such as, for example, the seller manually concluding the auction or the auction automatically concluding. Whether an auction is automatically or manually concluded, an auction winner is determined if the auction successfully concludes and no auction winner is determined where the auction unsuccessfully concludes. An auction may automatically conclude for any number of reasons defined at the time of auction generation. For example, if no bids are received by a specified auction end date and time, an auction may automatically terminate with no auction winner determined (i.e., unsuccessfully terminate). In another example, if the seller specifies price targets at the time the auction is generated and these price targets are not met by the specified end date and time of the auction, the auction may automatically terminate with no auction winner determined (i.e., unsuccessfully terminate). An auction may also automatically conclude in a traditional manner when a specified end date and time is reached with the highest bidder becoming the auction winner (i.e., the auction successfully terminates). An auction may also be set up to allow the seller to manual conclude the auction and/or to manually select auction winners. Regardless of how an auction concludes a determination 320 needs to be made regarding whether or not the auction has successfully identified a winner (i.e., the auction successfully terminated). Though a single winner is discussed for a successfully concluding auction, it is apparent that there may be multiple winners if more than one lot of an auction is created. For example, if an auction for 1 unit of product A is created with five 1 unit lots of product A there can be up to five auction winners.

If an auction does not successfully conclude with a determined winner 320, any generated quotation and/or reservation for the auction needs to be rescinded 325 before the integrated auction process ends 375. If an auction successfully concludes with an auction winner determined 320, an order may be created 330 in the seller's business information management system(s) in preparation for the winner performing any checkout procedures 335-365 and completing the auction transaction according to this embodiment. The order may be created 330 using the winner information and the quotation generated 315 during the publication process 310 and it may take into account the configurable order options specified for the auction. In conjunction with creating an order 330, an email notification may be sent to the winner 105 informing him/her about winning and providing a link, such as for example a URL link, in the email that the winning bidder may click on 335 to connect the buyer 105 to the seller's e-commerce site 115 according to one embodiment of the present invention. The buyer 105 may first need to login to the e-commerce site (e.g., a business-to-business e-commerce site) before the buyer may be presented with the order for the auction or, alternatively (if for example the login information is already stored or the buyer is already logged in) the buyer may immediately be presented with this information. Clicking on the link 335 in the email is only one means by which the winner 105 may initiate the checkout process for the auction. For example, the winner may also go to seller's e-commerce site on their own and retrieve their won auction information and continue the checkout process.

The checkout process according to one embodiment of the present invention includes filling out the auction order specific information that is still required, making a selection for each of the configurable order options (or accepting the default selection), and making order modification that the winning bidder 105 is allowed to make. The winning bidder 105 initiates the checkout process 335 using one of the available means, for example, by responding to a link in a winner notification email. As part of the checkout process, a buyer 105 may modify the selection for a configurable order option 340 instead of accepting a default value. If the buyer 105 decides to modify the configurable order option selection 340, the buyer 105 makes the appropriate selection 345 and then may continue with the checkout process. A buyer 105 may also be permitted by the seller 110 to modify the order. If allowed to do so, the buyer 105 may decide 350 whether to make order modifications 355 during the checkout process. If the buyer 105 decides to modify the order 350, the buyer makes the order modifications 355 and continues with the checkout process. The checkout process may also include providing shipping information, billing information and/or other information in order to complete the order 360. The winning bidder 105 may provide this information 360 in order to complete 365 the checkout process. On the completion of the checkout process 365, the order is released 370 meaning that any block on the order may be removed and the order may be processed by the seller's business information management system(s) 140 concluding 375 the internal auction process according to this embodiment of the present invention.

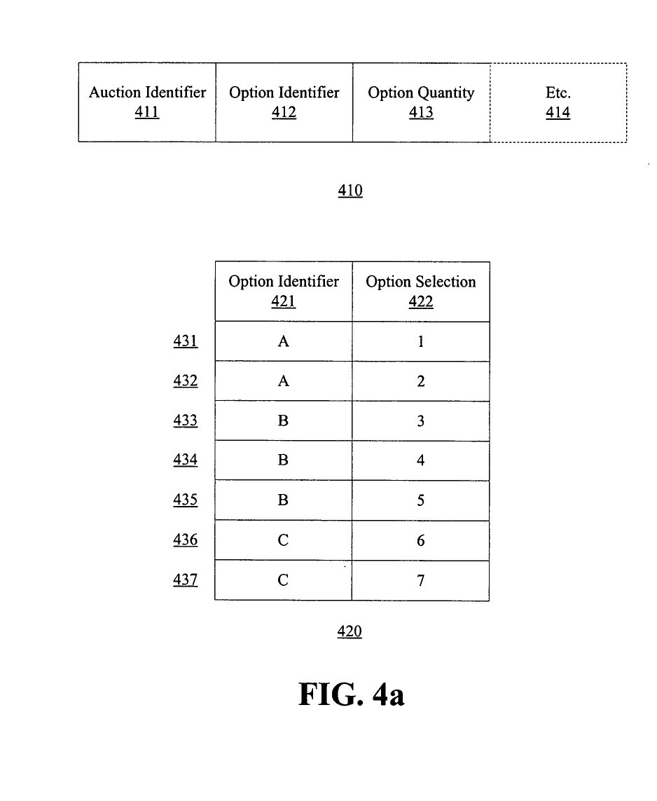

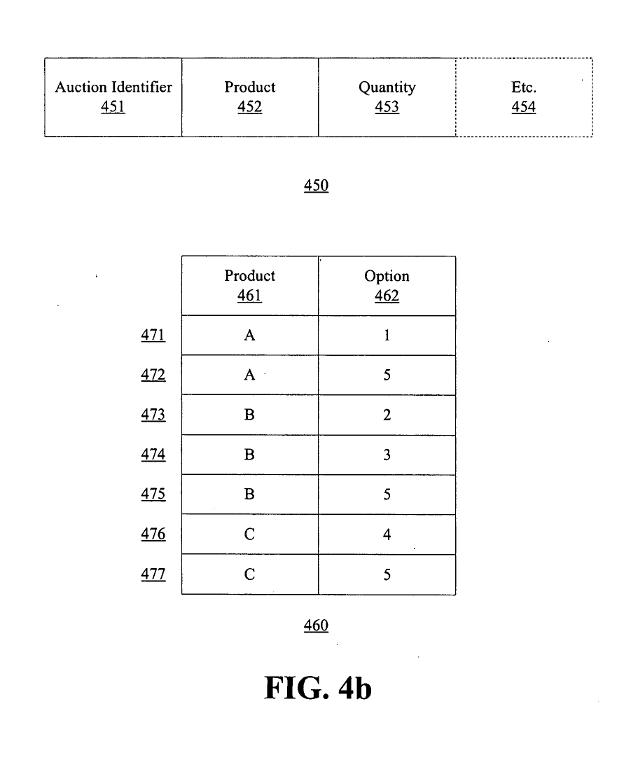

FIG. 4a is an example data architecture for implementing a configurable order option in an auction within an internal auction system according to one embodiment of the present invention. The data row 410 is a simplified example of the data fields in a row of a database table that may be used to associate a configurable order option with an auction according to one embodiment of the present invention. This data row 410 may be stored in at least one of the seller's business information management system(s) 140 databases 141 and/or the internal auction application 120 database 130 within the internal auction system 100. In this example, the data row 410 includes an auction identifier field 411 containing a unique identifier for the auction, a configurable order option identifier field 412 containing a unique identifier for the configurable order option, an option quantity field 413 which may include a quantity of the option available to the customer 105, and possibly other potential fields which are in aggregate represented by the single “Etc.” field 414 indicated by the dashed lines. There may be one data row 410 for each association of a configurable order option with an auction which may result in a number of data rows 410 for an auction where the auction identifier 411 is associated with separate configurable order option identifiers 412. In addition to the database table containing the data row 410, an additional lookup table 420 may also be used according to this embodiment to provide detailed information on the configurable order options. For example, a configurable order option lookup table 420 may contain a number of rows of data 431-437 associating an option identifier 412, 421 with an option selection 422. A configurable order option “A” 431-432 may be a product configuration option for product color with two options “1” 431 representing “red” and “2” 432 representing “blue”—the two colors a winning bidder 105 may choose from in this example. In another example, a configurable order option “B” 433-435 may be an accessory option such as a battery for a laptop computer with three options for battery life: “3” 433 a 2-hour battery; “4” 434 a 3-hour battery; and “5” 435 a 5-hour battery. In a third example, a configurable order option “C” 436-437 may be a cross-selling product option such as a case for a laptop computer with two options “6” 436 and “7” 437 representing different types of laptop cases. These examples serve to illustrate how a separate database lookup table 420 may be used to provide additional configurable order option information. In addition to this example table 420, other database tables and/or other fields in this table may be used to provide additional information relating to the configurable order options. According to the embodiment depicted in FIG. 4a, a configurable order option that is saved in the table 420 may be used in multiple auctions my simply linking the appropriate configurable order option identifier 412, 421 with the auction identifier 411. Therefore, stored configurable order options in, for example, the configurable order option data table 420 may be browsed and readily included in one or more auctions in various embodiments of the present invention. The term record, row, and tuple are used interchangeable herein to refer a record/row/tuple of data, the terms table and file are used interchangeably herein to refer to a table/file of a database, and the terms field and cell are used interchangeably herein to refer to a field/cell in row. These terms are not intended to imply a particular database structure (e.g., a hierarchical database or a relational database). Embodiments of the present invention may work effectively using any known database type and the present invention is not limited to a particular database structure.

FIG. 4b is an example data architecture for implementing a configurable order option associated with a product in an auction within an internal auction system according to one embodiment of the present invention. The data row 450 containing the main auction information does not include a configurable order option identifier 412 as shown in FIG. 4a. The example data row 450 contains an auction identifier field 451 containing a unique identifier for the auction, a product field 452 identifying the product, a quantity field 453 indicating the quantity of the product in the auction, and it may contain other potential fields indicated in the aggregate by the dashed lines of the “Etc.” field 454. Instead of using a configurable order option identifier 412, the embodiment shown in FIG. 4b directly associates the product identifier 452, 461 with a configurable order option selection 462, uniquely affiliating a product in a seller's business information management system(s) with a configurable order option according to this embodiment. The product-to-configurable order option table 460 contains the information regarding which configurable order options are generally associated with a product. When a product is added to an auction, the general configurable order options that are already associated with the product may also be brought into the auction as well. This may be done automatically in one embodiment or may require an affirmative step by the seller 110 (i.e., a seller action) in another embodiment of the present invention. For example, a seller 110 adding a product may be presented with buttons in the seller-side application 121 of the internal auction application 120 allowing the seller 110 to browse and import existing configurable order options already associated with the product. In the product-to-configurable order option table 460, information for three products—product “A” 471-472, product “B” 473-475, and product “C” 476-477—are included in the table 460 with each product 461 having a number of configurable order options 462. Product “A” 471, 472 is affiliated with configurable order options “1” 471 and “5” 472, product “B” 473-475 is affiliated with configurable order options “2” 473, “3” 474, and “5” 475, and product “C” 476, 477 is affiliated with configurable order options “4” 476 and “5” 477. In addition to the general associations shown in the product-to-configurable order option table 460, additional configurable order options may be added to an auction or these existing options may be modified or deleted for the product in a particular auction during the auction creation process and/or the auction editing/modification process. FIG. 4b shows one embodiment of how configurable order option information may already be associated with a product to illustrate how these general (not specific to one auction) configurable order options may be imported into an auction. In addition to these general product configurable order options, other configurable order options may also be added to the auction.

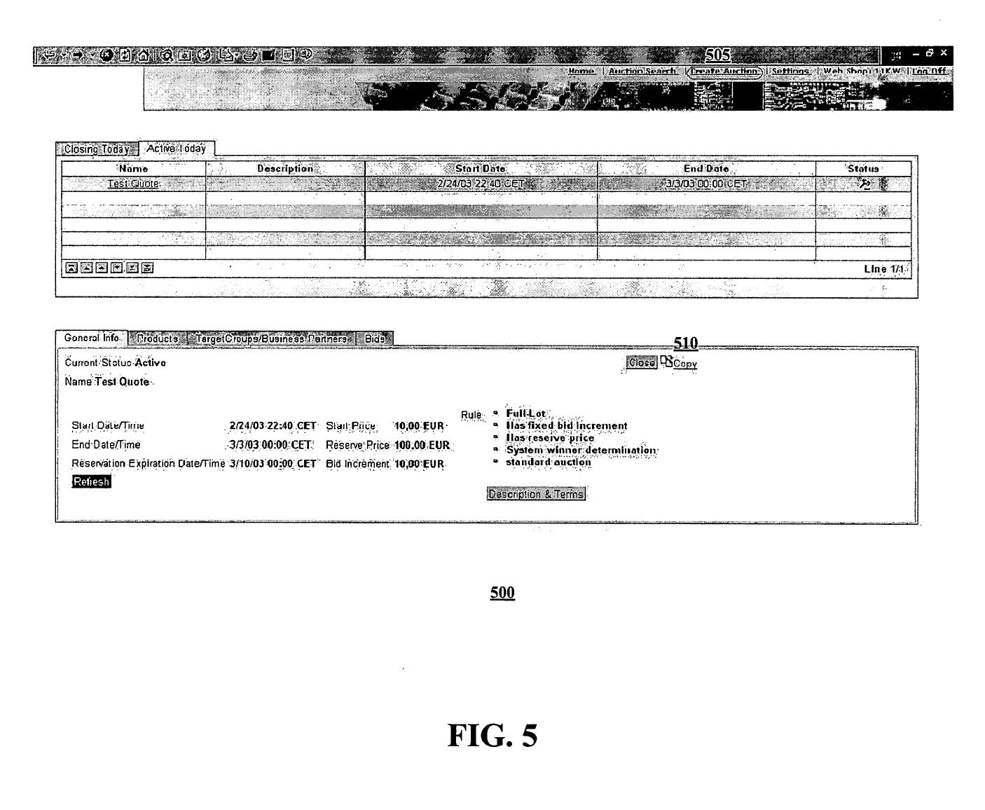

FIG. 5 is a screen shot from an internal auction application illustrating an auction listing screen from which a seller may choose to create a new auction or edit an existing auction where a configurable order option may be included according to one embodiment of the present invention. According to this embodiment, the internal auction application 120 links a seller's existing business information management system(s) 140 with a seller's e-commerce site 115 in order to provide internal auction services. The internal auction application 120 may be a component-based multi-tier application developed according to the Java® 2 platform, enterprise edition standard (J2EE®) and running on top of the web application server (WAS) according to this embodiment. This embodiment is only one example of the platforms and software that may be used for the internal auction application 120. A seller 110 may use the seller-side application 121 of the internal auction application 120 to create or edit an auction. Creating an auction may be initiated by selecting a create option link 505 on an appropriate screen 500 of the internal auction application 120, such as the auction listing screen 500 shown, or through the use of menu items (not shown), buttons (not shown), or other known means (not shown). An auction may also be created by selecting an existing auction and then selecting (e.g., clicking on) a “Copy” link 510, button (not shown), menu option (not shown), or other selection means (not shown). Once the seller 110 initiates the create auction process, an auction creation screen may be displayed. An auction may also be edited by selecting the desired auction followed by selecting the edit option (not shown).

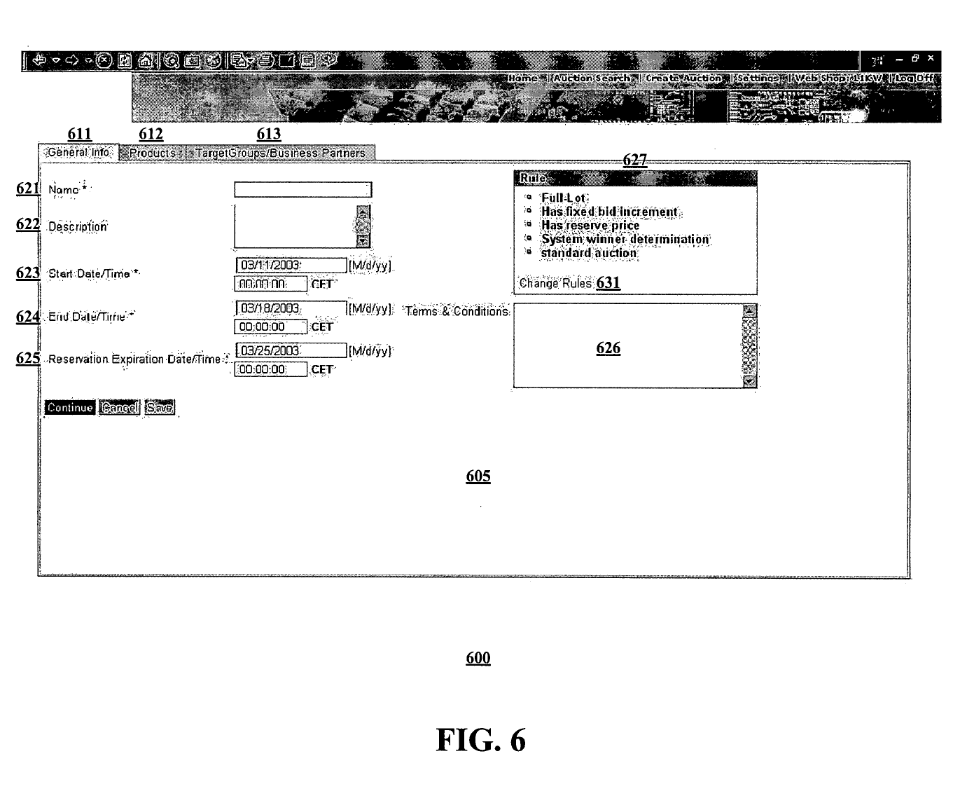

FIG. 6 is a screen shot from an internal auction application illustrating an auction creation screen from which a configurable order option may be specified according to one embodiment of the present invention. The auction creation screen 600 includes an auction creation table 605 containing three tabs 611-613 for the auction information. The first tab 611 is the “General Info” tab and contains the general auction information that a seller 110 may specify according to this embodiment. An auction name 621, auction description 622, start date and time 623, end date and time 624, reservation expiration date and time 625, terms and condition 626, and auction rules 627 may be specified in this “General Info” tab 611. If the auction is created by copying an already created auction, these fields 621-627 may initially be populated with data from the copied auction. If the auction is not being created from a copied auction, these fields 621-627 may contain default values and/or may be empty. For example, the auction rules 627 field may contain a default listing of rules for the seller 110. If the seller 110 wants to change these rules, the seller 110 may select the “Change Rules” link 631 or other provided option to make the appropriate changes. In one embodiment of the present invention, configurable order options may be included in the “General Info” tab 611 of the auction creation table 605 using configurable order option entry fields (not shown) and/or through auction rules.

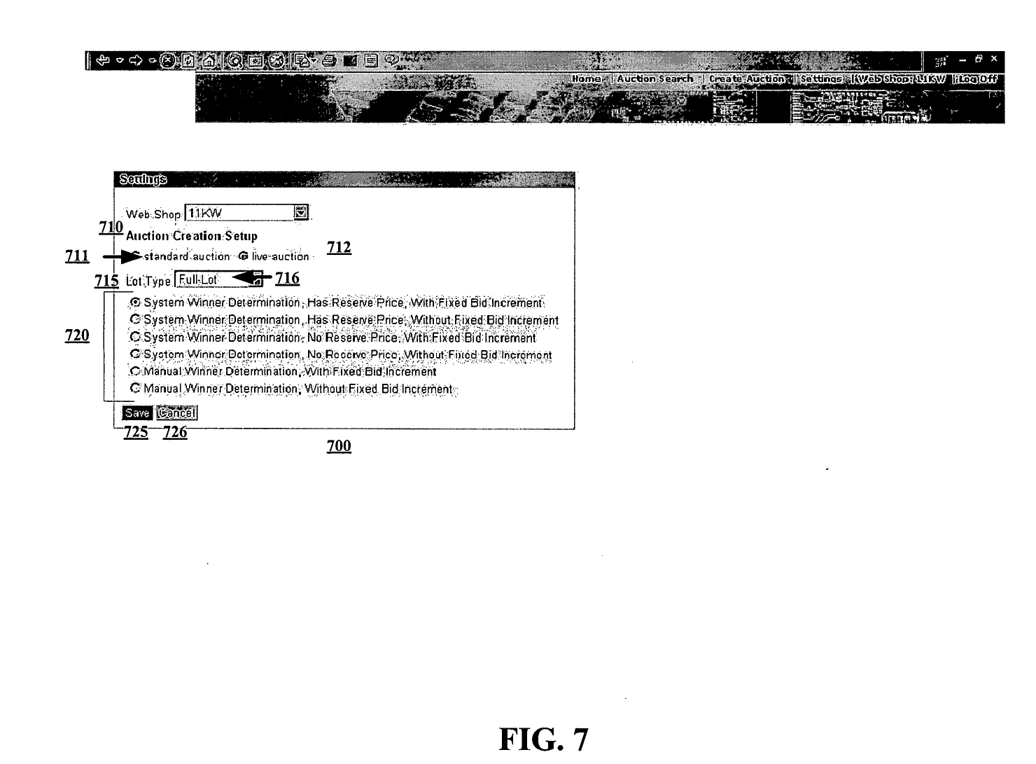

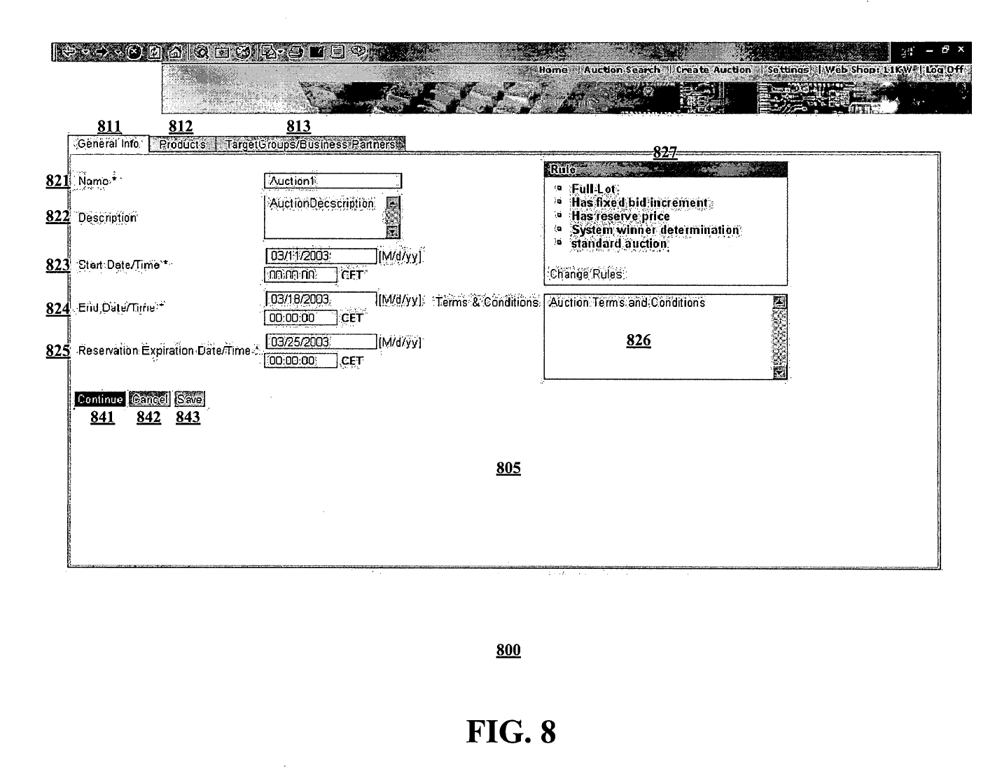

FIG. 7 is a screen shot from an internal auction application illustrating the change rules screen presented to a seller during the auction creation process according to one embodiment of the present invention. When a seller 110 initiates the “Change Rules” option, the change rules screen 700 may be displayed with the selected rules shown. For example, an auction type 710 may be selected such as a standard auction 711 and a live auction 712. A lot type 715 may also be selected such as the full lot type 716 shown. A full lot may indicate that the entire contents of the auction are sold together to a winning bidder rather than a broken lot auction where the highest bidder may bid on and win a portion of the auction up to the specified auction quantity with the next highest bidder winning part or all of the remaining portion of the lot, etc. Other system rules 720 are indicated in a radio field of rule combinations which a seller 110 may select. The rules shown in the radio field 720 may be broken down into more detailed selection options (not shown) and other rules may also be included (not shown). The seller's changes to these auction rules may be saved 725 or they may be canceled 726 with the internal auction application 120 returning to the auction creation screen 600 and the auction creation table 605 shown in FIG. 6. FIG. 8 is a screen shot from an internal auction application illustrating the auction creation screen with general auction information entered according to one embodiment of the present invention. Auction information in the “General Info” tab 811 of the auction creation table 805 has been entered in this embodiment in the auction name field 821, auction description field 822, start date and time fields 823 (default data), end date and time fields 824 (default data), reservation expiration date and time fields 825 (default data), terms and condition field 826, and auction rules table 827. At any time during the auction creation process, the seller 110 may cancel 842 the auction creation process without saving the auction information already entered by selecting the Cancel button 842 or by other appropriate means (not shown). The seller 110 may also save 843 the auction data by selecting the Save button 843 or by other appropriate means (not shown). The seller 110 may continue entering information for the auction by selecting (clicking on) the Continue button 841 or by selecting another tab 812, 813 of the auction creation table 805.

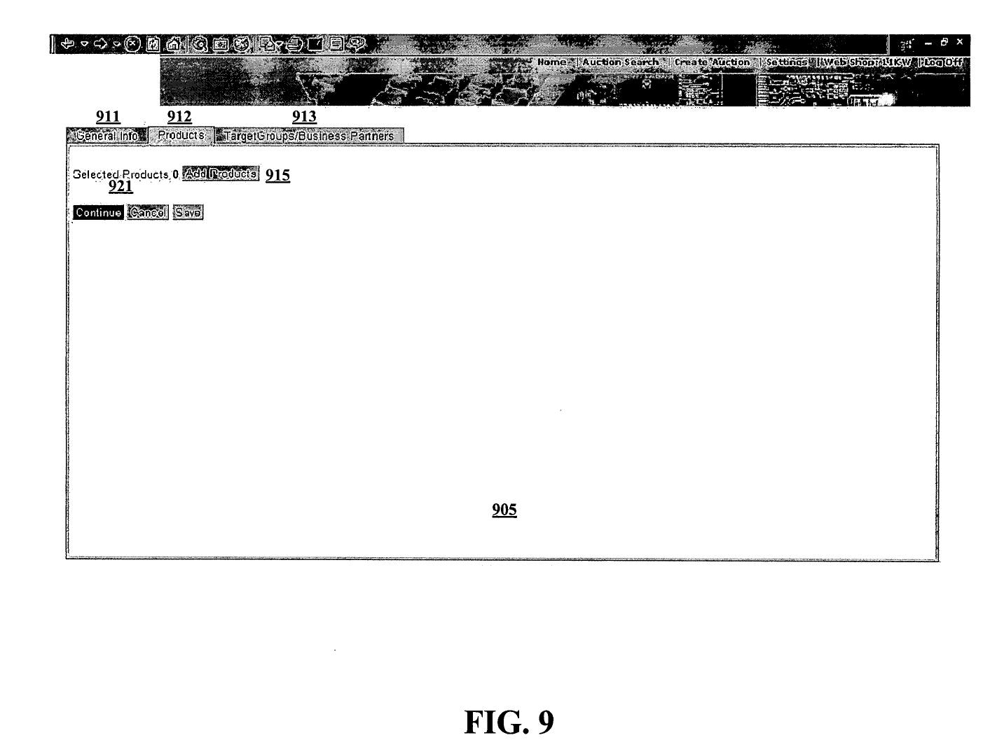

FIG. 9 is a screen shot from an internal auction application illustrating the initiation of a process to add a product to an auction which may also associate configurable order options with the auction according to one embodiment of the present invention. In addition to entering general auction information in the “General Info” tab 911 of the auction creation table 905 and target groups for bidder restrictions in the “Target Groups/Business Partners” tab 913, the seller 110 may also designate products and product information for the auction using the “Products” tab 912 of the auction creation table 905. When the seller 110 selects the “Products” tab 912, existing products already selected for the auction may be displayed (not shown) or if no products have been selected for the auction a message stating so (not shown) may be displayed. In addition, a message 921 may be displayed according to this embodiment indicating the number of products selected for the auction. The embodiments discussed herein relate to products but in other embodiments services as well as or instead of products may also be used. From this screen, the seller 110 may add a product to the auction by selecting (e.g., clicking on) the “Add Products” button 915.

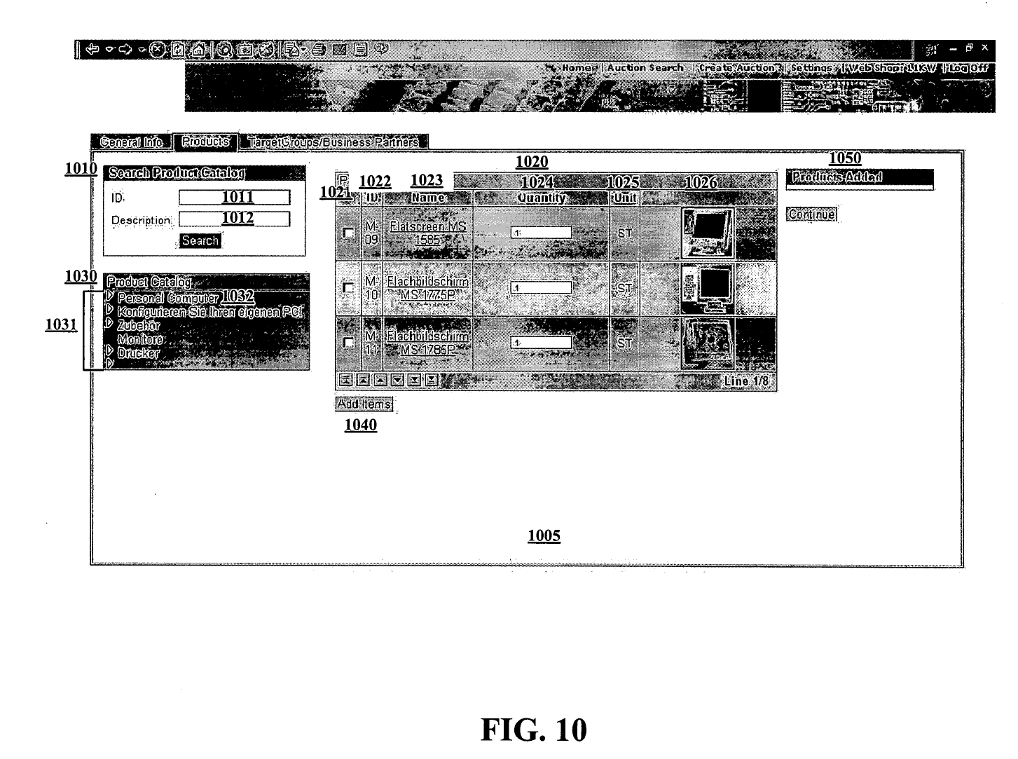

FIG. 10 is a screen shot from an internal auction application illustrating the product designation screen of the auction creation process where a product may be included in an auction according to one embodiment of the present invention. The auction creation table 1005 include a search box 1010 where a seller may designate enter a search parameter for a product identifier 1011 and/or a product description 1012 to retrieve products in a product listing 1020 to browse for inclusion in the auction. In addition to the search box 1010, a product catalog listing 1030 of product catalog categories 1031 such as, for example, personal computers 1032 may also be provided where the selection of a product category 1031 may result in the display of all products from that category in a product listing table 1020 from which the seller 110 may browse and select products for inclusion into the auction. The product listing 1020 is a table of the products retrieved using the search options provided in the search box 1010, the product catalog categories 1030, and/or by other means (not shown). The product listing table 1020 includes a product identifier 1022, a product name 1023, a product quantity 1024, a product unit identifier 1025 and a product image 1026 as well as a check box 1021 for each product in the listing according to this example embodiment. A seller 110 may add a product to the auction by selecting a product from within the listing 1020 by checking the check box 1021 of the product (which may be accomplished by clicking a pointing device on the appropriate checkbox 1021) and then by selecting (e.g., clicking on) the “Add Items” button 1040 or by other means such as a pull-down menu option (not shown). Products that have already been added to the auction are shown in the products added table 1050 which is empty in the example shown in FIG. 10.

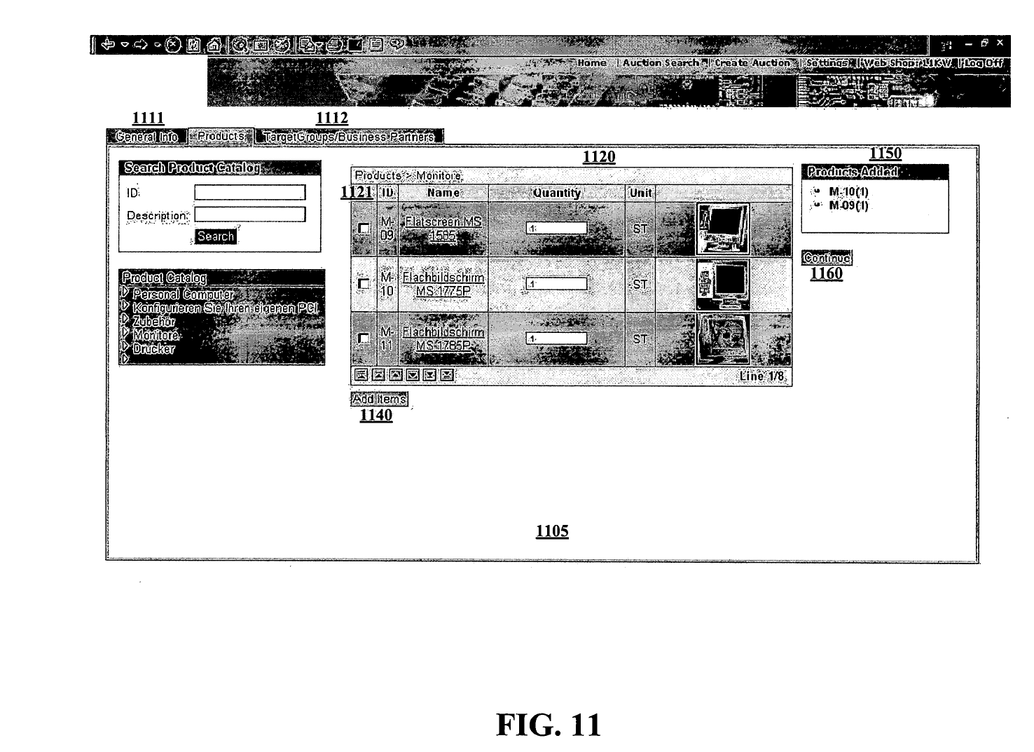

FIG. 11 is a screen shot from an internal auction application illustrating the adding of a product to an auction on the product designation screen during the auction creation process according to one embodiment of the present invention. A seller 110 may add a product to the auction by selecting a product from within the product listing table 1120 as previously discussed. A seller 110 may select a product by, for example, clicking a pointing device on the check box 1121 of the product in the product listing table 1120 resulting in a check or other indication appearing in the check box 1121. The seller 110 may then select (e.g., clicking on) the “Add Items” button 1140 or use some other means such as an “Add Items” option in a pull-down menu (not shown) to add the selected product(s) to the auction. Once a product is added to the auction, it may appear in the added products table 1150. In the example shown in FIG. 11, two products have been added to the auction: a computer monitor with product identifier M-10 in a quantity of one unit indicated by the “(1)” following the product identifier; and a computer monitor with product identifier M-09 in a quantity of one unit indicated by the “(1)” following the product identifier. Once the seller 110 has concluded adding a product to the auction or at any time during the process, the seller 110 may select the “Continue” button 1160 or click on another tab 1111, 1112 in the auction creation table 1105 to continue with the auction creation process according to this embodiment of the present invention.

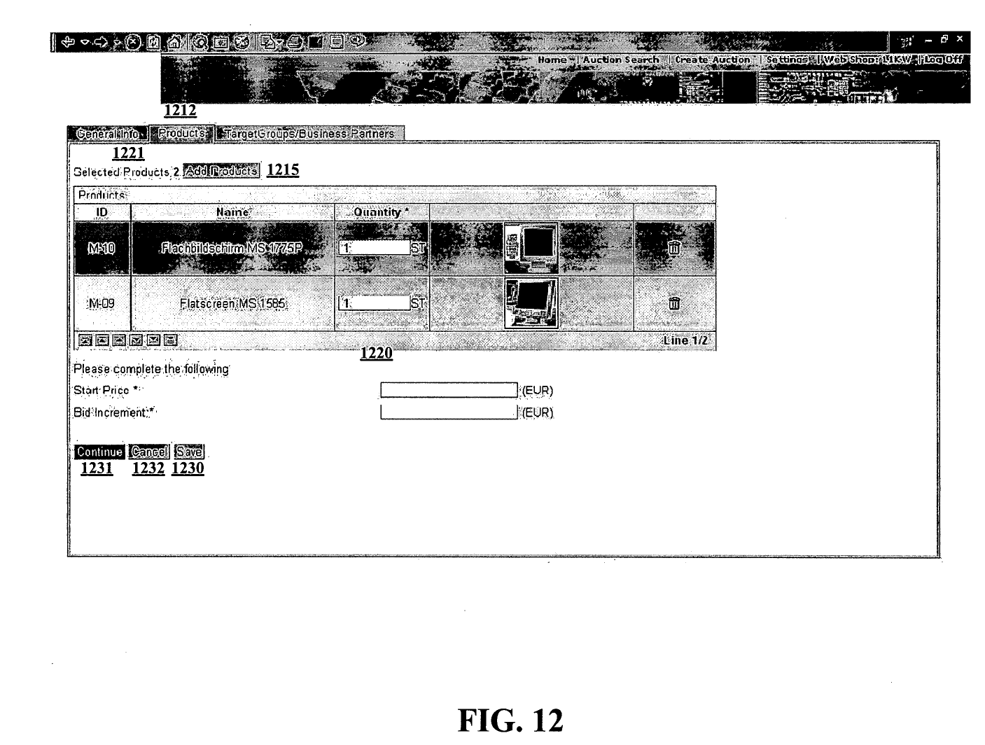

FIG. 12 is a screen shot from an internal auction application illustrating the selected products for an auction which may also associate configurable order options with the auction according to one embodiment of the present invention. As previously discussed regarding the “Products” tab 1212, existing products already selected for the auction may be displayed in a product listing table 1220. In addition, a message 1221 may be displayed according to this embodiment indicating the number of products selected for the auction—in this example, 2. The seller 110 may continue to add products to the auction by selecting (e.g., clicking on) the “Add Products” button 1215 or the seller may “Save” 1230 the auction information. As previously stated, the seller 110 may also “Continue” 1231 with the auction creation process or “Cancel” 1232 the process altogether by making the appropriate selection 1231, 1232. The “Product” tab 1212 may also list the configurable order options associated with each product (not shown) in either the product listing table 1220 or separately in one embodiment. In an alternative embodiment, a separate configurable order options tab (not shown) may be used to show this information.

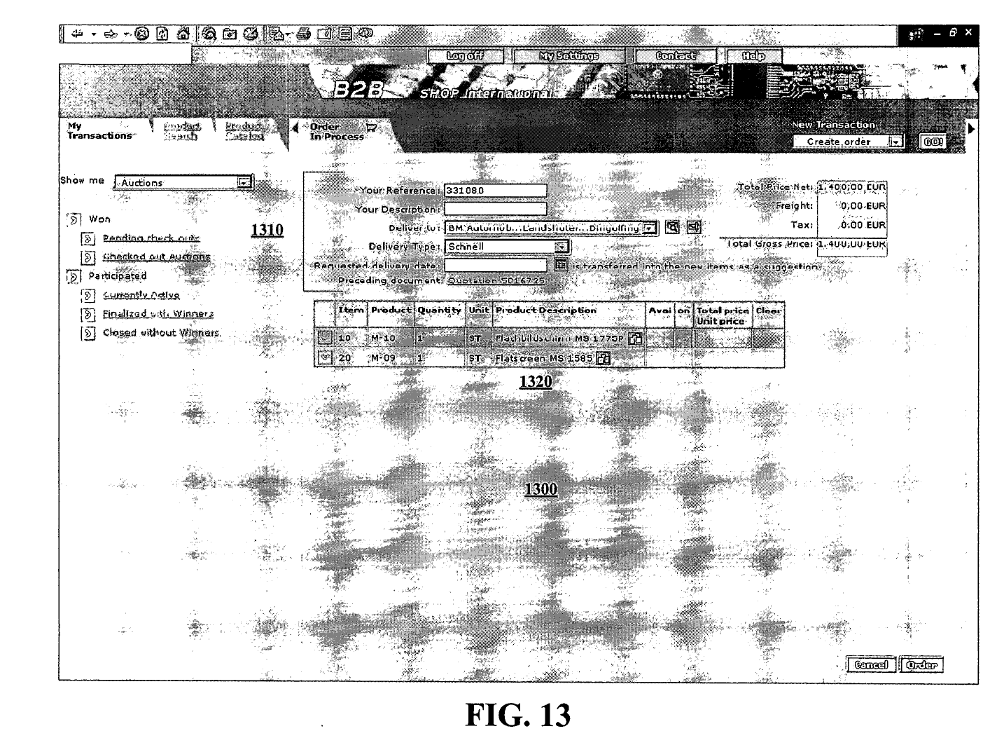

FIG. 13 is a screen shot from a seller's e-commerce site illustrating an auction order processing page available to a winning bidder through a seller's e-commerce site that may contain configurable order options according to one embodiment of the present invention. General auction and product information are shown on the auction order screen 1300 of the seller e-commerce site 115 according to this embodiment. According to this embodiment, general auction parameters 1310 that a winning bidder 105 may need to provide during the checkout process and the product data 1320 for the auction are shown on the screen 1300. A configurable order option may be shown with a product in the product data 1320 (not shown)—i.e., with the table of product data 1320—or a configurable order option may be presented separately on the screen (not shown). For example, a configurable order option field (not shown) may present selection options to a winning bidder 105 in a drop-down selection list format. If a product configuration option allowing a winning bidder 105 to select from one of three colors for a product is used, a selection list (drop-down list) may be presented along with the product data 1320 in the table on the screen or it may be shown elsewhere on the screen such as, for example, in a configurable options table (not shown) in various embodiments of the present invention.

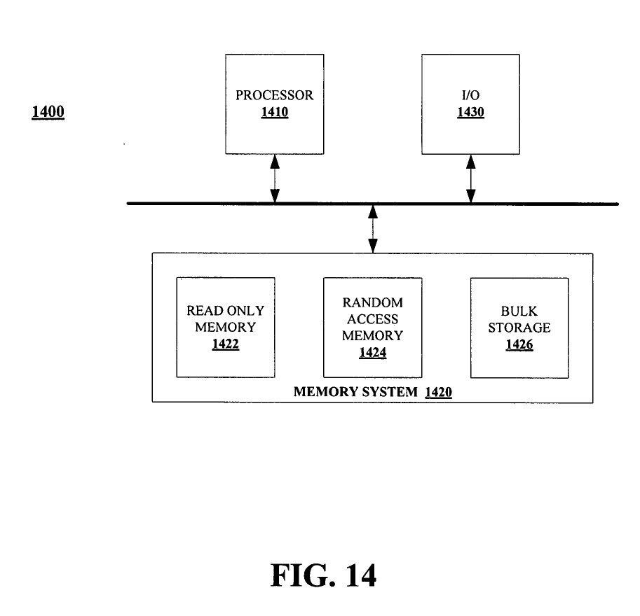

FIG. 14 is a block diagram illustrating the platform on which the method and system for providing a configurable order option for an auction in an internal auction system using an internal auction application may operate according to one embodiment of the present invention. Functionality of the foregoing embodiments may be provided on various computer platforms executing program instructions. One such platform 1400 is illustrated in the simplified block diagram of FIG. 14. There, the platform 1400 is shown as being populated by a processor 1410, a memory system 1420 and an input/output (I/O) unit 1430. The processor 1410 may be any of a plurality of conventional processing systems, including microprocessors, digital signal processors and field programmable logic arrays. In some applications, it may be advantageous to provide multiple processors (not shown) in the platform 1400. The processor(s) 1410 execute program instructions stored in the memory system. The memory system 1420 may include any combination of conventional memory circuits, including electrical, magnetic or optical memory systems. As shown in FIG. 14, the memory system may include read only memories 1422, random access memories 1424 and bulk storage 1426. The memory system not only stores the program instructions representing the various methods described herein but also can store the data items on which these methods operate. The I/O unit 1430 would permit communication with external devices (not shown).

What is claimed is:

1. A method for providing a configurable order option for an auction in an internal auction system using an internal auction application, comprising:
creating the auction as a function of a seller interaction with the internal auction application, wherein the auction is a function of at least one communication with a seller's business information management system;
adding a product to the auction, wherein the product is defined in the seller's business information management system;
modifying the auction to include the configurable order option for the product wherein the configurable order option is at least one of an already defined configurable order option associated with the product in the seller's business information management system and an auction-specific configurable order option for the product in the auction; and
presenting the configurable order option for the product in the auction to a buyer as part of a checkout process, wherein the buyer is an auction winner.

2. The method according to claim 1, wherein the configurable order option is at least one of a product configuration option, an accessory option, a cross-selling product option, an up-sell product option, and a down-sell product option.

3. The method according to claim 1, the adding step further comprising;
adding a product to the auction as a function of the at least one communication with the seller's business information management system, wherein the product is defined in the seller's business information management system.

4. The method according to claim 1, the presenting step further comprising:
presenting through a seller's e-commerce site the configurable order option for the product in the auction to a buyer as part of a checkout process, wherein the buyer is an auction winner.

5. The method according to claim 1, further comprising:
receiving by the internal auction application a selection for the configurable order option, the selection made by the buyer.

6. The method according to claim 6, further comprising:
communicating the selection for the configurable order option as part of an auction order to the seller's business information management system, wherein the seller's business information management system processes the auction order.

7. The method according to claim 6, further comprising:
processing by the internal auction application the selection for the configurable order option; and
communicating the processed selection for the configurable order option as part of an auction order to the seller's business information management system.

8. A method for providing a configurable order option for an auction in an internal auction system using an internal auction application, comprising:
receiving by a seller's business information management system a product parameter from the internal auction application, wherein the seller's business information management system includes at least one of an inventory functionality and a product catalog and the product parameter identifies a product;
retrieving a product data item from the seller's business information management system as a function of the received product parameter;
identifying by the seller's business information management system the configurable order option for the product as a function of the received product parameter, wherein the configurable order option is associated with the product in the seller's business information management system;
returning at least one of the product data item and the configurable order option to the internal auction application for inclusion in the auction;
receiving an order for the auction wherein the order includes a configurable order option selection for the configurable order option; and
processing the order for the auction as a function of the configurable order selection.

9. The method according to claim 8, wherein the product parameter identifies a product.

10. The method according to claim 8, wherein the configurable order option is at least one of a product configuration option, an accessory option, a cross-selling product option, an up-sell product option, and a down-sell product option.

11. The method according to claim 8, wherein the order is a buyer order placed with a seller through a seller e-commerce network site as a function of the buyer winning the auction.

12. A system for providing a configurable order option for an auction in an internal auction system using an internal auction application, comprising:
a memory system;
an input/output unit; and
a processor, wherein the processor is adapted to:
(i) create the auction as a function of a seller interaction with the internal auction application, wherein the auction is a function of at least one communication with a seller's business information management system;
(ii) add a product to the auction, wherein the product is defined in the seller's business information management system;
(iii) modify the auction to include the configurable order option for the product wherein the configurable order option is at least one of an already defined configurable order option associated with the product in the seller's business information management system and an auction-specific configurable order option for the product in the auction; and
(iv) present the configurable order option for the product in the auction to a buyer as part of a checkout process, wherein the buyer is an auction winner.

13. A system for providing a configurable order option for an auction in an internal auction system using an internal auction application, comprising:
a memory system;
an input/output unit; and
a processor, wherein the processor is adapted to:
(i) receive by a seller's business information management system a product parameter from the internal auction application, wherein the seller's business information management system includes at least one of an inventory functionality and a product catalog and the product parameter identifies a product;
(ii) retrieve a product data item from the seller's business information management system as a function of the received product parameter;
(iii) identify by the seller's business information management system the configurable order option for the product as a function of the received product parameter, wherein the configurable order option is associated with the product in the seller's business information management system;
(iv) return at least one of the product data item and the configurable order option to the internal auction application for inclusion in the auction;
(v) receive an order for the auction wherein the order includes a configurable order option selection for the configurable order option; and
(vi) process the order for the auction as a function of the configurable order selection.

14. A computer readable medium including instructions adapted to execute a method for providing a configurable order option for an auction in an internal auction system using an internal auction application, the method comprising:
creating the auction as a function of a seller interaction with the internal auction application, wherein the auction is a function of at least one communication with a seller's business information management system;
adding a product to the auction, wherein the product is defined in the seller's business information management system;
modifying the auction to include the configurable order option for the product wherein the configurable order option is at least one of an already defined configurable order option associated with the product in the seller's business information management system and an auction-specific configurable order option for the product in the auction; and
presenting the configurable order option for the product in the auction to a buyer as part of a checkout process, wherein the buyer is an auction winner.

15. A computer readable medium including instructions adapted to execute a method for providing a configurable order option for an auction in an internal auction system using an internal auction application, the method comprising:
receiving by a seller's business information management system a product parameter from the internal auction application, wherein the seller's business information management system includes at least one of an inventory functionality and a product catalog and the product parameter identifies a product;
retrieving a product data item from the seller's business information management system as a function of the received product parameter;
identifying by the seller's business information management system the configurable order option for the product as a function of the received product parameter, wherein the configurable order option is associated with the product in the seller's business information management system;
returning at least one of the product data item and the configurable order option to the internal auction application for inclusion in the auction;
receiving an order for the auction wherein the order includes a configurable order option selection for the configurable order option; and
processing the order for the auction as a function of the configurable order selection.
